(19) United States
(12) Patent Application Publication
(10) Pub. No.: US 2015/0334193 A1
(43) Pub. Date: Nov. 19, 2015

(54) METHOD AND APPARATUS FOR INTER-LOCAL NETWORK COMMUNICATION

(71) Applicant: Samsung Electronics Co., Ltd., Gyeonggi-do (KR)

(72) Inventors: Kiho CHO, Gyeonggi-do (KR); Chanho JUNG, Seoul (KR)

(73) Assignee: Samsung Electronics Co., Ltd.

(21) Appl. No.: 14/713,606

(22) Filed: May 15, 2015

(30) Foreign Application Priority Data
May 15, 2014 (KR) 10-2014-0058253

(51) Int. Cl. H04L 29/08

(52) U.S. Cl. CPC H04L 67/141; H04L 67/32

(57) ABSTRACT

A method of an inter-local network communication of a first electronic device is provided. The method includes obtaining, by the first electronic device, address information of a second electronic device in a second local network, from a third electronic device, forming a communication channel with the second electronic device, based on the address information, and transferring data between the first local network and the second local network, using the communication channel.

### PRIORITY

This application claims priority under 35 U.S.C. §119(a) to Korean Patent Application No. 10-2014-0058253, which was filed in the Korean Intellectual Property Office on May 15, 2014, the entire content of which is incorporated herein by reference.

### BACKGROUND

1. Field of the Invention

The present invention relates generally to a local network communication service.

2. Description of Related Art

Local networks having electronic devices positioned in therein, either geographically or virtually, may be implemented so that the electronic devices are connected to transmit and receive data between each other. Likewise, electronic devices positioned in another local network may such that the electronic devices positioned in that local network transmit and receive data between each other. Furthermore, inter-local network communication may be supported and performed. When the inter-local network communication is supported, a corresponding communication module and communication method should be supported. When various inter-local network communications are performed, a communication network and a protocol supporting a communication within a local network should be built, and a communication network, a protocol, and the like supporting a communication between the local networks should be separately built. Designing and building new communication networks and protocols for transmitting data in the local networks to another local network may be a huge load.

### SUMMARY

The present invention has been made to address at least the problems and disadvantages described above, and to provide at least the advantages described below.

Accordingly, an aspect of the present invention is to provide an inter-local network communication more simply.

Accordingly, another aspect of the present invention is to effectively used an existing resource (e.g., a socket can be reused) in managing inter-local network communication.

In accordance with an aspect of the present invention, a method of an inter-local network communication of a first electronic device in a first local network is provided. The method of the first electronic device includes obtaining, by the first electronic device, address information of a second electronic device in a second local network, from a third electronic device, forming a communication channel with the second electronic device, based on the address information, and transferring data between the first local network and the second local network, using the communication channel.

In accordance with another aspect of the present invention, a first electronic device for supporting an inter-local network communication is provided. The first electronic device includes a a communication module configured to support a communication connection in a first local network and a communication connection with a second local network, and a control module configured to control the communication module to obtain address information of a second electronic device in the second local network, form a communication channel with the second electronic device in the second local network based on the address information, and transfer data between the first local network and the second local network, using the communication channel.

In accordance with another aspect of the present invention, a non-transitory computer-readable recording medium having recorded thereon, a program for executing a method of an inter-local network communication of a first electronic device in a first local network, the program including the steps of obtaining address information of a second electronic device in a second local network, from a third electronic device, forming a communication channel with the second electronic device, based on the address information, and transferring data between the first local network and the second local network, using the communication channel.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a schematic diagram illustrating a configuration of an inter-local network communication system, according to an embodiment of the present invention;

FIG. 2 is a block diagram of a configuration of an electronic device in an inter-network communication system, according to an embodiment of the present invention;

FIG. 3 is a block diagram of a control module in an electronic device in an inter-network communication system, according to an embodiment of the present invention;

FIG. 4A is a flowchart of a management method related to inter-local network communication for an electronic device in an inter-local network communication system, according to an embodiment of the present invention;

FIG. 4B is a a flowchart of a management method related to an inter-local network communication for an electronic device in an inter-local network communication system, according to an embodiment of the present invention.

FIGS. 5A and 5B are screen interfaces related to an inter-network communication of an electronic device in an inter-local network communication system, according to an embodiment of the present invention; and

FIG. 6 is a block diagram of an electronic device, according to an embodiment of the present invention.

### DETAILED DESCRIPTION OF EMBODIMENTS OF THE PRESENT INVENTION

Hereinafter, the present invention will be described with reference to the accompanying drawings. The present invention may have various modifications and embodiments and thus will be described in detail with reference to specific embodiments illustrated in the drawings. However, it should be understood that there is no intent to limit the present invention to the particular forms disclosed herein; rather, the present invention should be construed to cover all modifications, equivalents, and/or alternatives falling within the spirit and scope of the invention.

In the description of the drawings, identical or similar reference numerals are used to designate identical or similar elements.

In the present invention, the expression “include” or “may include” refers to existence of a corresponding function, operation, or element, and does not limit one or more additional functions, operations, or elements. Also, as used herein, the terms “include” and/or “have” should be construed to denote a certain feature, number, step, operation, element, component or a combination thereof, and should not be construed to exclude the existence or possible addition of one or more other features, numbers, steps, operations, elements, components, or combinations thereof.

In the present invention, the expression “or” includes any or all combinations of words enumerated together. For example, the expression “A or B” may include A, may include B, or may include both A and B.

In the present invention, expressions including ordinal numbers, such as “first” and “second,” etc., may modify various elements. However, such elements are not limited by the above expressions. For example, the above expressions do not limit the sequence and/or importance of the corresponding elements. The above expressions may be used merely for the purpose of distinguishing one element from the other elements. For example, a first user device and a second user device indicate different user devices although both of them are user devices. For example, a first element may be termed a second element, and similarly, a second element may be termed a first element without departing from the scope of the present invention.

When an element is referred to as being “coupled” or “connected” to any other element, it should be understood that not only may the element be directly coupled or connected to the other element, but also a third element may be interposed between the two elements. Contrarily, when a element is referred to as being “directly coupled” or “directly connected” to any other element, it should be understood that no element is interposed between the two elements.

The terms used in the present disclosure are only used to describe specific embodiments, and are not intended to limit the present invention. As used herein, the singular forms are intended to include the plural forms as well, unless the context clearly indicates otherwise.

Unless defined otherwise, all terms used herein, including technical and scientific terms, have the same meaning as those commonly understood by a person of ordinary skill in the art to which the present invention pertains. Such terms as those defined in a generally used dictionary are to be interpreted to have the meanings equivalent to the contextual meanings in the relevant field of art, and are not to be interpreted to have ideal or excessively formal meanings unless clearly defined in the present specification.

An electronic device according to the present invention may be a device including a communication function. For example, the electronic device may include at least one of a smart phone, a tablet Personal Computer (PC), a mobile phone, a video phone, an e-book reader, a desktop PC, a laptop PC, a netbook computer, a PDA, a Portable Multimedia Player (PMP), an MP3 player, a mobile medical device, a camera, a wearable device (for example, a Head-Mounted-Device (HMD), such as electronic glasses, electronic clothes, an electronic bracelet, an electronic necklace, an electronic appcessory, an electronic tattoo, and a smart watch.

According to some embodiments, the electronic device may be a smart home appliance with a communication function. The smart home appliances may include at least one of, for example, Televisions (TV), Digital Versatile Disk (DVD) players, audio players, refrigerators, air conditioners, cleaners, ovens, microwaves, washing machines, air purifiers, set-top boxes, TV boxes (e.g., HomeSync™ of Samsung, Apple TV™, or Google TV™), game consoles, electronic dictionaries, electronic keys, camcorders, or electronic frames.

According to some embodiments, the electronic device may include at least one of various types of medical devices (for example, Magnetic Resonance Angiography (MRA), Magnetic Resonance Imaging (MRI), Computed Tomography (CT), a scanning machine, ultrasonic wave device and the like), a navigation device, a Global Positioning System (GPS) receiver, an Event Data Recorder (EDR), a Flight Data Recorder (FDR), a car infotainment device, ship electronic equipment (for example, navigation equipment for a ship, a gyro compass and the like), avionics, a security device, and an industrial or home robot.

According to another embodiment, the electronic devices may include at least one of furniture or a part of a building/structure having a communication function, electronic boards, electronic signature receiving devices, projectors, or various measuring equipment (e.g., equipment for a water supply, an electricity, gases or radio waves).

The electronic device according to the present invention may be a combination of one or more of the aforementioned various devices. Further, it should be obvious to those skilled in the art that the electronic device according to the present invention is not limited to the aforementioned devices.

Hereinafter, an electronic device according to various embodiments of the present invention will be described with reference to the accompanying drawings. In various embodiments, the term “user” may indicate a person using an electronic device or a device (e.g.

an artificial intelligence electronic device) using an electronic device.

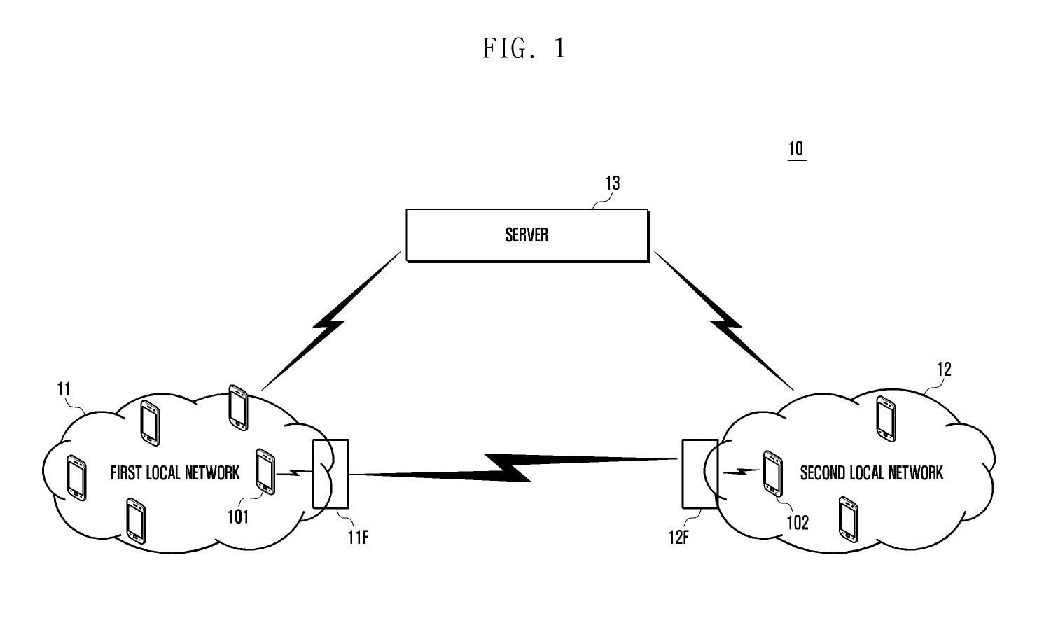

FIG. 1 is a schematic diagram illustrating a configuration of an inter-local network communication system, according to an embodiment of the present invention.

Referring to FIG. 1, the inter-local network communication system 10 includes a first local network 11, a second local network 12, and a server 13.

The inter-local network communication system 10 supports such that a designated electronic device (hereinafter, a first electronic device 101) of the first local network 11 communicates with a designated electronic device (hereinafter, a second electronic device 102) of the second local network 12. In this operation, the first electronic device 101 communicates with the second electronic device 102 through a first firewall 11F and a second firewall 12F of the second local network 12. Similarly, the second electronic device 102 communicates with the first electronic device 101 through the second firewall 12F and the first firewall 11F of the first local network 11.

The first firewall 11F and the second firewall 12F support so as to transmit and receive data to and from a predetermined electronic device. For example, the first firewall 11F processes to receive data having a first address value. The second firewall 12F processes to receive data having a second address value. The first firewall 11F and the second firewall 12F may be designed so as not to limit a data transmission operation. Alternatively, the first firewall 11F and the second firewall 12F may limit a data transmission or a data size in a data transmission operation according to a design method.

The first local network 11 includes at least one electronic device. The electronic devices in the first local network 11 may be connected to each other through at least one of a wired method and a wireless method. The first electronic device 101 of the first local network 11 controls a local network service with the remaining electronic devices. The first electronic device 101 connects a communication channel with the remaining electronic devices in the first local network 11. For example, the first electronic device 101 connects the communication channel with the remaining electronic devices in the first local network 11 through a socket communication. For example, the first electronic device 101 generates a socket (hereinafter, a local socket) for communicating with other electronic devices in the first local network 11. For example, the local socket may be a socket of ZeroMQ method. However, in the embodiment of the present invention, the local socket is not limited to the socket of the ZeroMQ method, and the local socket may be a socket of various methods (e.g., a Transmission Control Protocol (TCP) or a User Datagram Protocol (UDP)).

The first electronic device 101 includes a local network control module that controls a search and data transmission between electronic devices within the first local network 11. The local network control module may be a Software Development Kit (SDK), for example, Samsung Chord SDK.

The local network control module of the first electronic device 101 controls communication with other local networks (e.g., the second local network 12). For example, the local network control module of the first electronic device 101 controls to form a communication channel between the second electronic device 102 and the first local network 11. For example, the local network control module of the first electronic device 101 forms the communication channel with the second electronic device 102 through a hole punching technique. For example, the local network control module of the first electronic device 101 generates a socket (hereinafter, a hole punching socket) for the communication between the second electronic device 102 of the second local network 12 and the first local network 11. For example, the hole punching socket may be a socket of a TCP method. However, in the embodiment of the present invention, the hole punching socket is not limited to the socket of the TCP method, and may be a socket of various methods (e.g., UDP or ZeroMQ).

The local network control module of the first electronic device 101 reuses information of the hole punching socket to generate the local socket. For example, the first electronic device 101 may apply “SO_REUSEADDR” or “SO_REUSEPORT” options to the hole punching socket to generate a local socket having information equal to that of the hole punching socket. Alternatively, the first electronic device 101 generates a copy socket bound to address information (e.g., an IP address or a port number) equal to that of the hole punching socket using the “SO_REUSEADDR” or “SO_REUSEPORT” options and change the local socket to the copy socket. As another alternative, the first electronic device 101 may change previously generated information of the local socket such that the previously generated information of the local socket is equal to the information of the hole punching socket.

Further, the first electronic device 101 gives a control authority of the hole punching socket to the local network service using the local socket. For example, a handler of the hole punching socket is transferred to the local network service (or a control module controlling the local network service) to enable the local network service (or the control module controlling the local network service) to control the hole punching socket. Here, the “SO_REUSEADDR” and “SO_REUSEPORT” options are two of various options used in a socket communication, since the “SO_REUSEADDR” and “SO_REUSEPORT” options are widely used and known in the art, a detailed description concerning these options will be omitted. In addition, hereinafter, for a convenience of description, the above-mentioned methods are referred to as a reuse of a hole punching socket and described.

Since the hole punching socket is reused as the local socket, the local network control module of the first electronic device 101 may use a local network service (e.g., Samsung Chord SDK, a messenger operated in the local network, a video conference, and the like) of the second local network 12 in which the second electronic device 102 is included.

The first firewall 11F may be included in the first local network 11 or at least one electronic device in the first local network 11. The first firewall 11F may limit communication between local networks of at least one electronic device in the first local network 11. For example, the first firewall 11F may selectively limit a reception of data transmitted to the first electronic device 101. Specifically, the first firewall 11F may receive data having a designated address value and transfer the data having the designated address value to the first electronic device 101. Alternatively, the first firewall 11F may receive only data transmitted from the second electronic device 102 and transfer the data transmitted from the second electronic device 102 to the first electronic device 101.

The second local network 12 is formed by a connection between electronic devices for a communication. The electronic devices in the second local network 12 are connected to communicate through at least one of a wired method and a wireless method. The second local network 12 may be a local network geographically or virtually independent from the first local network 11.

Like the first electronic device 101, the second electronic device 102 of the second local network 12 includes a local network control module. For example, the local network control module of the second electronic device 102 controls a local network service with other electronic devices in the second local network 12 through a local socket. In addition, the local network control module of the second electronic device 102 controls communication with other local networks (e.g., the first local network 11). For example, the local network control module of the second electronic device 102 may use a local network service operated in the first local network 11 through a reuse of the hole punching socket. For example, the second electronic device 102 may apply “SO_REUSEADDR” or “SO_REUSEPORT” options to the hole punching socket to generate a local socket having information equal to that of the hole punching socket. Alternatively, the second electronic device 102 may generate a copy socket bound to address information (e.g., an IP address or a port number) equal to that of the hole punching socket using the “SO_REUSEADDR” or “SO_REUSEPORT” options and change the local socket to the copy socket. As another alternative, the second electronic device 102 may change previously generated information of the local socket such that the previously generated information of the local socket is equal to the information of the hole punching socket.

Further, the second electronic device 102 gives a control authority of the hole punching socket to the local network service using the local socket.

The second firewall 12F may be included in the second local network 12 or at least one electronic device in the second local network 12. Similar to the first firewall 11F, the second firewall 12F may limit communication between local networks of at least one electronic device in the second local network 12. For example, the second firewall 12F may selectively limit a reception of data transmitted to the second electronic device 102. Specifically, the second firewall 12F may receive data having a designated address value and transfer the data having the designated address value to the second electronic device 102. Alternatively, the second firewall 12F may receive data transmitted from the first electronic device 101 and transfer the data transmitted from the first electronic device 101 to the second electronic device 102.

The server 13 supports communication between the first local network in which the first firewall 11F is disposed and the second local network 12 in which the second firewall 12F is disposed. The server 13 may include a Traversal Using Relay NAT (TURN) server device, a Simple Traversal of User Datagram Protocol (UDP) through Network Address Translators (NATs) (STUN), or the like. For example, the server 13 may be a Smart Connectivity Solution (SCS) server.

The server 13 stores address information of at least one electronic device in the first local network 11 and at least one electronic device in the second local network 12. For example, the server 13 stores public Internet Protocol (IP) information, private IP information, or port information of the electronic devices positioned in the first local network 11 and the electronic devices positioned in the second local network 12 as the address information.

The server 13 supports direct communication between electronic devices in local networks having different firewalls, using the stored address information. For example, the server 13 supports a communication channel generation between the first electronic device 101 and the second electronic device 102 using a hole punching technique. For example, the server 13 generates a hole punching socket between the first electronic device 101 and the second electronic device 102 and supports a communication channel connection based on the generated hole punching socket.

As described above, the system 10 supporting the inter-network communication, according to an embodiment of the present invention does not change a communication method, a communication module, a protocol, or the like designed to be managed in the local network, and supports to reuse the hole punching socket generated for direct communication between electronic devices in different networks as the local socket for the communication in the local network. For example, the first electronic device 101 in the first local network 11 may use the local network service in the second local network 12 through the reuse of the hole punching socket. Similarly, the second electronic device 102 in the second local network 12 may use the local network service in the first local network 11. That is, the embodiment of the present invention expands a local network area where the local network service is provided to include another local network area.

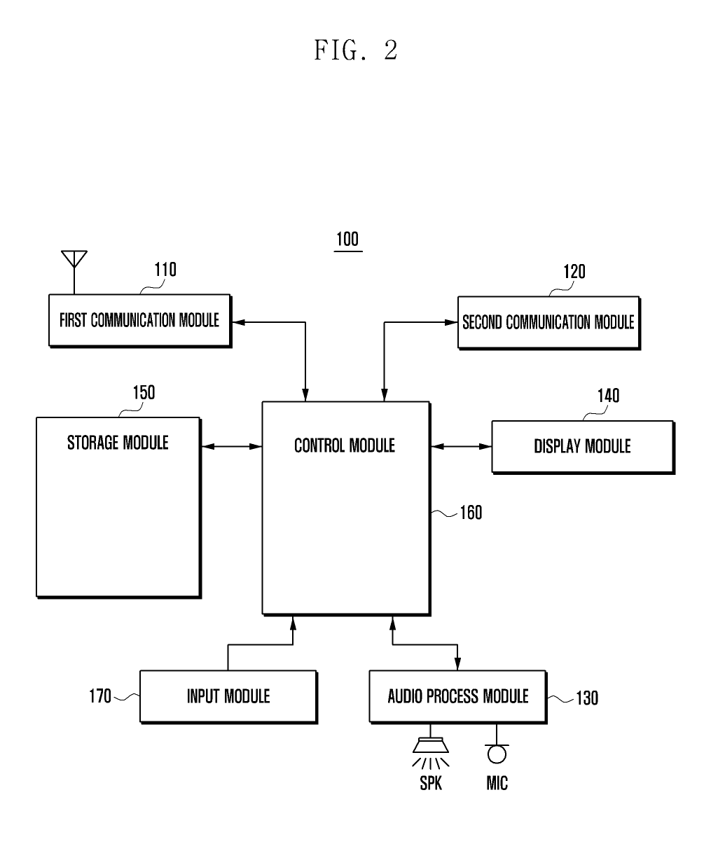

FIG. 2 is a block diagram of a configuration of an electronic device in a configuration of an inter-network communication system, according to an embodiment of the present invention.

Referring to FIG. 2, electronic device 100 is provided. The electronic device 100 reuses the hole punching socket generated in relation to the inter-local network communication to transmit and receive data collected during the communication in the local network. Electronic device 100 is an electronic device disposed in at least one network of the first local network 11 and the second local network 12. For example, an electronic device 100 may be the first electronic device 101 of the first local network 11. Alternatively, the electronic device 100 may be the second electronic device 102 of the second local network 12. Hereinafter, for a description of an operation of the first electronic device 101 in the first local network 11 or the second electronic device 102 in the second local network 12, reference numeral 100 is used to refer to each of the first electronic device 101 and the second electronic device 102. However, when a function division of a transmitting side and a receiving side is necessary, each of the first electronic device 101 and the second electronic device 102 may be described correspondingly to each case.

The electronic device 100 includes a first communication module 110, a second communication module 120, an audio process module 130, a display module 140, a storage module 150, a control module 160, and an input module 170.

The first communication module 110 supports communication in a local network or an inter-local network communication. The first communication module 110 is a communication module (e.g., a wired Local Area Network (LAN)) supporting a wired network or a communication module (e.g., a Wi-Fi communication module) supporting a short range wireless network.

The first communication module 110 forms a communication channel with another electronic device in the local network through a local socket under control of the control module 160. The first communication module 110 transmits and recieves data to and from the other electronic device in the local network under the control of the control module 160.

In addition, the first communication module 110 forms a remote communication channel with an electronic device in the other local network under the control of the control module 160. For example, the first communication module 110 generates the hole punching socket using a hole punching technique under the control of the control module 160 and forms the remote communication channel with the designated electronic device of the other local network through the generated hole punching socket.

The first communication module 110 obtains address information of the electronic device in the other local network from the server 13 under the control of the control module 160, and forms the remote communication channel based on the obtained address information. The first communication module 110 transmits and receives data to and from the electronic device in the other local network using the remote communication channel.

The first communication module 110 reuses the hole punching socket for the remote communication as the local socket for local communication under the control of the control module 160. For example, the first communication module 110 transmits data collected from the local network to the electronic device in the other local network or receives data from the electronic device in the other local network under the control of the control module 160.

The second communication module 120 may be a mobile communication module supporting a mobile communication function. For example, the second communication module 120 may be a 3^{rd} Generation (3G) or 4^{th} Generation (4G) communication module.

The second communication module 120 forms a communication channel with the server under control of the control module 160. For example, when the second communication module 120 cannot form a remote communication channel with the electronic device in the other local network through the first communication module 110 under the control of the control module 160, the second communication module 120 receives address information of the electronic device in the other local network from the server 13 and forms the remote communication channel based on the received address information. The second communication module 120 transmits data obtained from the local network to the electronic device in the other local network under the control of the control module 160and receives data obtained from the local network from the electronic device in the other local network under the control of the control module 160.

The audio process module 130 outputs an audio signal generated in a management operation of the electronic device 100. The audio process module 130 collects an audio signal requested in the management operation of the electronic device 100. For example, the audio process module 130 includes at least one of a speaker and a microphone. The speaker ouputs the audio signal. The microphone collects the audio signal. The audio process module 130 may output an audio signal transmitted and received to and from the other electronic device in the local network. The audio process module 130 may additionally output an audio signal received from the other local network. The audio process module 130 may collect an audio signal to be transmitted to the other local network. The audio signal transmitted or collected through the audio process module 130 is transmitted and received using the hole punching socket generated through the hole punching technique.

The display module 140 displays at least one screen related to the management of the electronic device 100. For example, the display module 140 displays various screens such as a standby screen, a menu screen, a designated function performance screen, a sleep screen in which a power supply is cut off, and a lock screen. The display module 140 may include a display panel and a touch panel or a touch sheet. The display module 140 may be used as an input means based on the touch panel or the touch sheet. For example, the display module 140 may support a hand touch or a pen touch. A touch event generated from the display module 140 is transferred to the control module 160 and is managed as a designated command or a command set.

The display module 140 displays a first communication screen related to the other electronic devices in the local network. The first communication sceen displays identification information of the other electronic devices in the local network to each of desinated and divided areas. When the electronic device 100 transmits and receives image information to and from the other electronic devices in the local network, the first communication screen is a screen which includes images corresponding to each of the other electronic devices in the local network. Alternatively, when the electronic device 100 transmits and receives data (e.g., text or image information) to and from the other electronic devices in the local network, the first communication screen is a screen which displays the data (e.g., the text or image information) provided from each of the other electronic devices in the local network to the divided areas on the first communication screen.

While the first communication screen divides and displays data transmitted and received to and from each of the other electronic devices in the local network, the audio process module 130 may output an audio signal transmitted and received to and from at least one of the other electronic devices in the local network.

The display module 140 display a second communication screen related to the electronic devices in the other local network. For example, the second communication screen is a screen related to electronic devices in the second local network 12, rather than the first local network 11 in which the electronic device 100 is currently included. Alternatively, the second communication screen may be a screen related to electronic devices in the first local network 11 and the second local network 12.

The storage module 150 stores various pieces of data and programs related to the management of the electronic device 100. For example, the storage module 150 may store an operating system related to the management of the electronic device 100, data related to a communication platform of the first communication module 110, communication protocol data related to management of the first communication module 110, data related to a communication platform of the second communication module 120, or communication protocol data related to a management of the second communication module 120.

According to an embodiment, the storage module 150 may temporarily store address information of the hole punching socket generated through the hole punching technique. The temporarily stored address information of the hole punching socket may be used by the control module 160 for managing the communication in the local network. The address information may also be stored in the server 13.

The storage module 150 temporarily stores data related to the first communication screen and data related to the second communication screen. The storage module 150 stores at least one screen data of the first communication screen and the second communication screen, when a control request is generated. The storage module 150 also stores audio data generated in communication management.

The input module 170 generates an input signal related to the management of the electronic device 100. The input module 170 includes at least one key generating an input signal. The input module 170 includes various keys such as a side key, a home key, a volume key, and a power key. The input module 170 includes a touch pad, a touch panel, a touch sheet and the like. When the display module 140 is arranged as a touch screen form, the display module 140 is included in the input module 170. The above-mentioned input module 170 generates an input signal related to the communication management in the local network, an input signal related to the communication management the inter-local network, and the like. According to an embodiment, the input module 170 generates an input signal requesting a connection with the other local network during the communication management in the local network, an input signal requesting a disconnection with the other local network in the state in which the other local network is connected, and the like. The generated input signal is transferred to the control module 160 to be operated as a command or a command set related to a corresponding function performance.

The control module 160 controls generation and transmission of a control signal related to the management of the electronic device 100, execution of procesesses, transmission of data, etc. The control module 160 controls the communication management in the local network or inter-local network. The control module 160 controls the generation and transmission of the control signal related to communication control in the local network. Additionally, the control module 160 controls the collection, output, and transmission of data during communication management in the local network.

The control module 160 additionally controls the formation of the communication channel with the other local network. The control module 160 controls collection and output of data to and from the electronic devices in the other local network.

The control module 160 controls a communication connection with the other local network during communication management in the local network. For example, when the communication connection with the other local network is requested during communication management in the local network, the control module 160 generates a socket for communication with the electronic device in the other local network through a hole punching technique and reuses the generated socket or socket information as a socket for communication in the local network.

Alternatively, the control module 160 identifies whether the storage module 150 includes socket information for communication of the inter-local network, and when the storage module 150 includes the socket information for communication the inter-local network, the control module 160 reuses the stored socket information as the socket for communication in the local network.

In this operation, the control module 160 transmits the data collected from the local network to the other local network through the reused socket. Alternatively, the control module 160 transmits the data transferred from the other local network to the other electronic devices in the local network through the reused socket. The control module 160 outputs the data using at least one of the display module 140 and the audio process module 130.

As described above, the first communication module 110 processes both the communication in the local newtork and the inter-local network communication, and when the first communication module 110 cannot processes the inter-local network communication, the second communication module 120 processes the inter-local network communication. However, the present invention is not limited thereto. For example, according to an embodiment of the present invention, the electronic device 100 may process the communication (i.e., local communication) in the local network using the first communication module 110 and processes the inter-local network communication (i.e., a remote communication) using the second communication module 120.

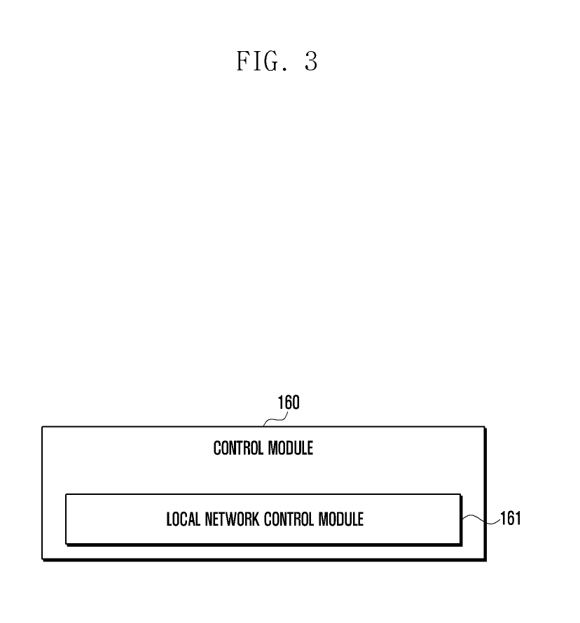

FIG. 3 is a block diagram of a control module in an electronic device in an inter-network communication system, according to an embodiment of the present invention.

Referring to FIG. 3, the control module 160 includes a local network control module 161.

The local network control module 161 forms a local communication channel with the electronic devices in the local network through at least one of a wired method and a wireless method. For example, the first electronic device 101 generates a local socket and connects a local communication channel with the electronic devices in the local network through the generated local socket (e.g., a ZeroMQ socket). When the local communication channel is connected, the local network control module 161 controls a search and a data transmission between the electronic devices in the local network.

The local network control module 161 controls remote communication with other local networks. For example, the local network control module 161 generates the hole punching socket through the hole punching technique when inter-local network communication is requested and forms the remote communication channel with the designated electronic device in the other local network through the generated hole punching socket. When the hole punching socket generation is finished, the local network control module 161 reuses the hole punching socket as the local socket. Since the hole punching socket is reused as the local socket, the local network control module 161 is able to control resources of the other local network.

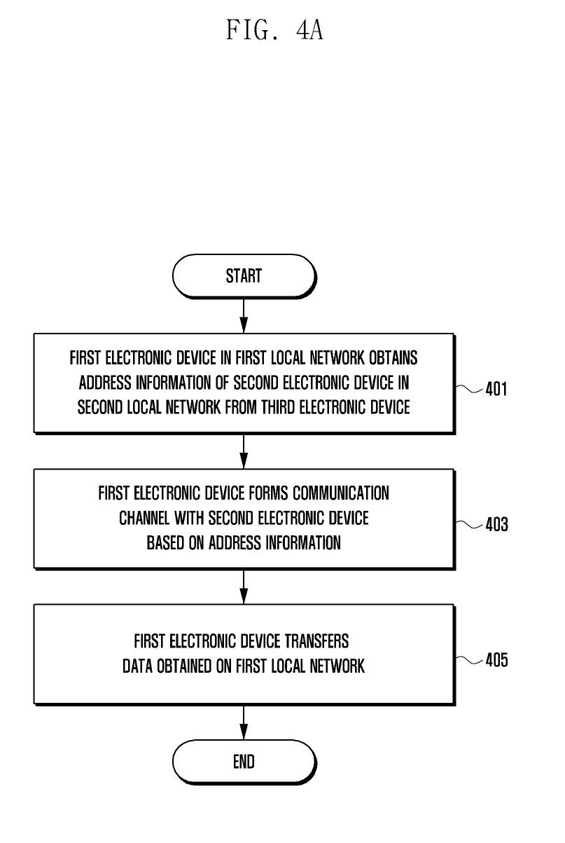

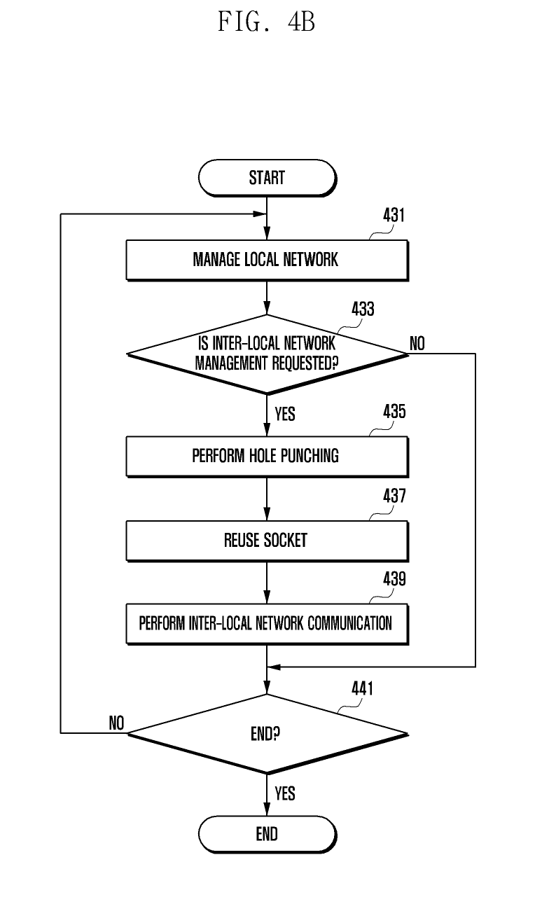

FIG. 4A is a flowchart of a management method related to inter-local network communication for an electronic device in an inter-local network communication system, according to an embodiment of the present invention.

Referring to FIG. 4A, it is assumed that a communication channel is connected between a first electronic device 101 and other electronic devices in a first local network 11, and a communication channel is connected between a second electronic device 102 and other electronic devices in a second local network 12. In addition, it is assumed that the first electronic device 101 and the second electronic device 102 are registered (e.g., logged in) to a third electronic device (e.g., the server 13) controlling a communication channel connection between the first local network 11 and the second local network 12. For example, it is assumed that address information of the first electronic device 101 or the second electronic device 102, which is necessary in the inter-local network communication connection is stored in the third electronic device (e.g., the server 13).

In step 401, the first electronic device 101 in the first local network 11 obtains address information of the second electronic device 102 in the second local network 12 from the third electronic device (e.g., the server 13).

In step 403, the first electronic device 101 forms a communication channel with the second electronic device 102 based on the obtained address information. For example, the first electronic device 101 generates the socket (e.g., the hole punching socket) for the communication connection between the first local network 11 and the second local network 12 through a hole punching technique, and forms the remote communication channel through the generated socket. In addition, the first electronic device 101 reuses the hole punching socket as the socket (i.e., the local socket) for communication in the first local network 11.

In step 405, the first electronic device 101 transfers data (e.g., an image, a video, a text, and the like) obtained from the first local network 11 to the second electronic device 102. The first electronic device 101 may also receive data from the second electronic device 102 obtained from the second local network 12. The first electronic device 101 may additionally use (or control) a local network service (e.g., a video conference, an IM service, Samsung Chord SDK, and the like) operated in the second local network.

The first electronic device 101 may output data received from the second electronic device 102 to a display module 140 or an audio process module 130 of the first electronic device 101.

FIG. 4B is a a flowchart of a management method related to an inter-local network communication for an electronic device in an inter-local network communication system, according to an embodiment of the present invention.

Referring to FIG. 4B, in step 431, the control module 160 of electronic device 100 manages a local network. The control module 160 controls to output, to the display module 140, a menu item or an icon related to the communication in the local network. When an input signal related to the menu item or the icon selection is detected, the control module 160 activates the first communication module 110. The control module 160 controls the communication connection with the electronic devices in the local network and data transmission between the electronic devices in the local network, based on the activated first communication module 110. For example, the control module 160 searches for other electronic devices in the local network, receives data from the other electronic device in the local network, and transmits data to the other electronic device in the local network. The control module 160 controls to output the received data through at least one of the display module 140 and the audio process module 130. In step 433the control module 160 determines whether an inter-local network management request is received. The control module 160 provides a menu item or an icon designated in relation to the inter-local network management request. Alternatively, the control module 160 allocates a function of the inter-local network management request to a designated button. When an input is detected at the designated menu item, icon or button, the control module 160 controls a connection with a predetermined other local network. Alternatively, when an input is detected at the designated menu item, icon or button, the control module 160 controls an address information input operation related to the designated electronic device of the other local network. The control module 160 displays a screen related to the address information input to the display module 140. The control module 160 provides a list of the designated electronic devices in one or more other local networks. When an item of the designated electronic device is selected in the list, the control module 160 controls a communication connection with the local network to which the designated electronic device belongs.

When the request for inter-local network management is not received, the control module 160 proceeds to step 441.

When the inter-local network management request is received the control module 160, in step 435, performs hole punching. The hole punching is a technique for forming a channel capable of communicating with an electronic device in the another local network through the server 13 as described above. The control module 160 generates the hole punching socket for inter-local network communication.

In step 437, the control module 160 reuses the hole punching socket. The control module 160 reuses the hole punching socket as the socket for the communication in the local network.

Alternatively, as described above, the control module 160 generates a copy socket, based on the information of the hole punching socket, and uses the generated copy socket as the socket for the communication in the local network.

In step 439, the control module 160 controls inter-local network data transmission and reception. The control module 160 transmits the data obtained from the local network through the reused socket to the electronic device of the other local network, and may receive data from the electronic device of the other local network through the reused socket. When the control module 160 receives the data from the electronic device in the other local network, the control module 160 transfers the received data to the electronic device in the local network.

In step 441, the control module 160 determines whether an input signal related to an end event for managing the inter-local network communication has been received.

When the input signal related to the end event is not received, the control module 160 performs steps 431, 433, 435, 437, 439 and 441 again.

When the input signal related to the end event is received, the control module 160 ends the inter-local network communication management of the electronic device 100. For example, the control module 160 transition the electronic device 100 to a sleep mode. Alternatively, the control module 160 controls to stop a power supply to the electronic device 100.

The control module 160 may additionally control to remove information output to the display module 140 when the input signal related to the end event is received.

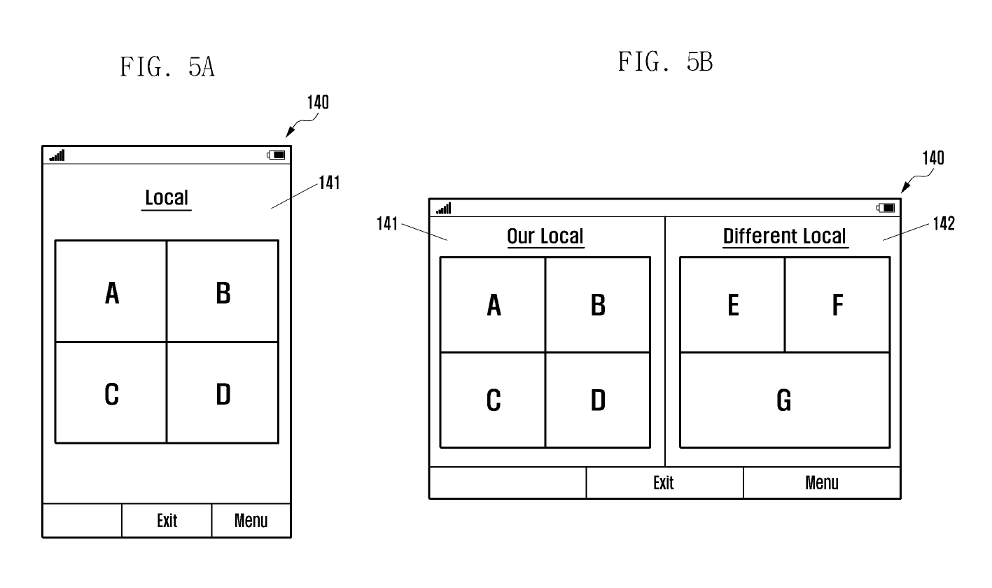

FIGS. 5A and 5B are screen interfaces related to an inter-network communication of an electronic device in an inter-local network communication system, according to an embodiment of the present invention.

Referring to FIG. 5A, the electronic device 100 outputs, to the display module 140, a first communication screen, including a first screen configuration 141 related to the communication in a local network. The first screen configuration 141 illustrates a configuration in which four electronic devices belong to the local network. The first screen configuration 141 may alternatively, illustration a configuration in which four electronic devices, among a plurality of electronic devices in the local network, are connected to communicate. The four electronic devices may share data with each other. For example, the screen of FIG. 5A may be output to each electronic device which is connected to communicate. Alternatively, the screen of FIG. 5A may be output to a designated electronic device, among the electronic devices connected to communicate.

In the The first screen configuration 141, areas “A, B, C, and D” may be areas related to data provided from each electronic device. For example, the areas “A, B, C, and D” may display static images or videos captured by cameras disposed at each of the electronic devices. The areas “A, B, C and D” may, alternatively, be areas where a text or an image input by each electronic device is displayed. When the four electronic devices collect and transfer audio data, the audio process module 130 may simultaneously recieves and outputs the audio data provided from the four electronic devices. Alternatively, the audio process module 130 may selectively output audio data provided from a designated electronic device corresponding to the control of the control module 160.

The areas “A, B, C and D” is changed according to an increase or a decrease of the number of the connected electronic devices. In this operation, the control module 160 resize the areas in the screen when the number of the electronic devices increases or decreases. For example, when the number of the electronic devices increases, the control module 160 resizes at least one area in the screen so that at least one area in the screen is smaller than before. When the number of the electronic devices decreases, the control module 160 resizes at least one area in the screen so that at least one area in the screen is larger than before.

Referring to FIG. 5B, In a state in which the communication in the local network is managed, when the inter-local network communication is requested, the control module 160 controls a connection of the inter-local network communication. In this operation, the display module 140 outputs a screen corresponding to the connection of the inter-local network communication. For example, the electronic device 100 outputs a second communication screen related to the inter-local network communication to the display module 140 as shown in FIG. 5B. The second communication screen includes the first screen configuration 141, related to the electronic devices in the local network, and a second screen configuration 142, related to the electronic devices in the other local network. To accommodate the second screen configuration 142, the control module 160 resizes the first screen configuration 141, such that the first screen configuration 141 is comparatively small compared to shown in FIG. 5A, and outputs the resized first screen configuration 141 together with the second screen configuration 142.

The electronic device 100 may receive data in another local network from a designated electronic device in the other local network. The display module 140 outputs the second screen configuration 142 based on the data received from the other local network. The second screen configuration 142 includes areas “E, F and G”. The areas “E, F and G” are areas corresponding to the electronic devices in the other local network. As described above, the areas “E, F and G” may be areas where at least one of a text and an image provided from the other electronic devices is output.

According to an embodiment, the electronic device 100 may output another screen including only the second screen configuration 142. For example, the control module 160 may remove the first screen configuration 141 from the display module 140 based on the reception of an input signal.

Alternatively, the control module 160 may remove one or more of the areas in the first screen configuration 141, according to the reception of an input signal.

As another alternative, the control module 160 may remove one or more of the areas in the second screen configuration 142, according to the reception of an input signal. When the connection with the other local network is ended, the control module 160 may remove the second screen configuration 142.

In the above-described embodiments, the first screen configuration 141 includes four areas, and the second screen configuration 142 includes three areas, but, the embodiments of the present invention is not limited thereto. For example, areas of the screen configuration may be changed by an increase or a decrease of the number of the electronic devices in the local network or the other local network.

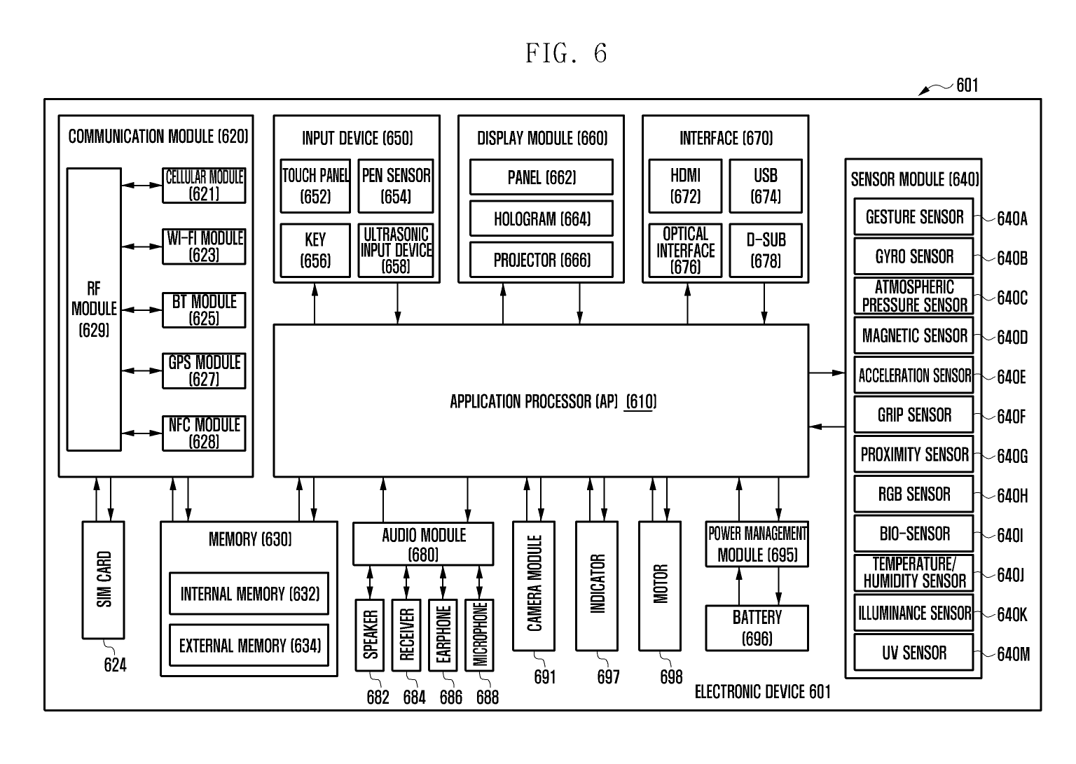

FIG. 6 is a block diagram of an electronic device, according to various embodiments of the present invention.

Referring to FIG. 6, the electronic device 601 includes one or more Application Processors (APs) 610, a communication module 620, a Subscriber Identification Module (SIM) card 624, a memory 630, a sensor module 640, an input device 650, a display 660, an interface 670, an audio module 680, a camera module 691, a power managing module 695, a battery 696, an indicator 697, and a motor 698.

The AP 610 operates an operating system (OS) or an application program to control a plurality of hardware or software component elements connected to the AP 610 and to execute various data processing and calculations, including multimedia data. For example, the AP 610 controls communication with other electronic devices in a local network and communication with other electronic device in another local network. The AP 610 reuses information of a socket for communicating with other electronic devices in the other local network to generate a socket for communicating in the local network. The AP 610 may be implemented by, for example, a System on Chip (SoC). The AP 610 may further include a Graphic Processing Unit (GPU).

The communication module 620 transmits/receives data in communication between different electronic devices connected to the electronic device 601 through a network.

According to an embodiment, the communication module 620 includes a cellular module 621, a Wi-Fi module 623, a BlueTooth (BT) module 625, a Global Positioning System (GPS) module 627, a Near Field Communication (NFC) module 628, and a Radio Frequency (RF) module 629.

The cellular module 621 provides a voice call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 621 may distinguish and authenticate electronic devices within a communication network by using a subscriber identification module (for example, the SIM card 624). The cellular module 621 may perform at least some of the functions which can be provided by the AP 610. For example, the cellular module 621 may perform at least some of the multimedia control functions.

The cellular module 621 may include a Communication Processor (CP). Further, the cellular module 621 may be implemented by, for example, an SoC. Although the components such as the cellular module 621 (for example, the communication processor), the memory 630, and the power managing module 695 are illustrated as components separate from the AP 610 in FIG. 6, the AP 610 may include at least some (for example, the cellular module 621) of the aforementioned components in an embodiment of the present invention.

The AP 610 or the cellular module 621 (for example, the communication processor) may load a command or data received from at least one of a non-volatile memory and other components connected to each of the AP 610 and the cellular module 621 to a volatile memory and process the loaded command or data. Further, the AP 610 or the cellular module 621 may store data received from at least one of other components or generated by at least one of other components in a non-volatile memory.

Each of the Wi-Fi module 623, the BT module 625, the GPS module 627, and the NFC module 628 includes a processor for processing data transmitted/received through the corresponding module. Although the cellular module 621, the Wi-Fi module 623, the BT module 625, the GPS module 627, and the NFC module 628 are illustrated as blocks separate from each other in FIG. 6, at least some (for example, two or more) of the cellular module 921, the Wi-Fi module 623, the BT module 625, the GPS module 627, and the NFC module 628 may be included in one Integrated Chip (IC) or one IC package, according to one embodiment of the present invention. For example, at least some of the processors (for example, the communication processor corresponding to the cellular module 621 and the Wi-Fi processor corresponding to the Wi-Fi module 623) corresponding to the cellular module 621, the WiFi module 623, the BT module 625, the GPS module 627, and the NFC module 628 may be implemented by one SoC.

The RF module 629 transmits/receives an RF signal. The RF module 629 may include a transceiver, a Power Amp Module (PAM), a frequency filter, a Low Noise Amplifier (LNA), or the like. Further, the RF module 629 may include a component for transmitting/receiving electronic waves over a free air space in wireless communication, for example, a conductor, a conducting wire, or the like. Although the cellular module 621, the Wi-Fi module 623, the BT module 625, the GPS module 627, and the NFC module 628 share one RF module 629 in FIG. 6, at least one of the cellular module 621, the Wi-Fi module 623, the BT module 625, the GPS module 627, and the NFC module 628 may transmit/receive an RF signal through a separate RF module according to one embodiment of the present invention.

The SIM card 624 is a card including a Subscriber Identification Module and is inserted into a slot formed in a particular portion of the electronic device. The SIM card 624 includes unique identification information (for example, Integrated Circuit Card IDentifier (ICCID)) or subscriber information (for example, International Mobile Subscriber Identity (IMSI).

The memory 630 (for example, the storage module 150) may include an internal memory 632 or an external memory 634.

The internal memory 632 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like). The internal memory 632 may be a Solid State Drive (SSD).

The external memory 634 may include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 634 is functionally connected to the electronic device 601 through various interfaces. According to an embodiment, the electronic device 601 may further include a storage device (or storage medium) such as a hard drive.

The sensor module 640 measures a physical quantity or detects an operation state of the electronic device 601, and converts the measured or detected information to an electronic signal. The sensor module 640 may include, for example, at least one of a gesture sensor 640A, a gyro sensor 640B, an atmospheric pressure (barometric) sensor 640C, a magnetic sensor 640D, an acceleration sensor 640E, a grip sensor 640F, a proximity sensor 640G, a color sensor 640H (for example, Red, Green, and Blue (RGB) sensor) 640H, a biometric sensor 640I, a temperature/humidity sensor 640J, an illumination (light) sensor 640K, and a Ultra Violet (UV) sensor 640M. Additionally or alternatively, the sensor module 640 may include, for example, an E-nose sensor, an electromyography (EMG) sensor, an electroencephalogram (EEG) sensor, an electrocardiogram (ECG) sensor, an InfraRed (IR) sensor, an iris sensor, a fingerprint sensor, and the like. The sensor module 640 may further include a control circuit for controlling one or more sensors included in the sensor module 640.

The input device 650 includes a touch panel 652, a (digital) pen sensor 654, a key 656, and an ultrasonic input device 658.

The touch panel 652 recognizes a touch input in at least one type of a capacitive type, a resistive type, an infrared type, and an acoustic wave type. The touch panel 652 may further include a control circuit. In the capacitive type, the touch panel 652 can recognize proximity as well as a direct touch. The touch panel 652 may further include a tactile layer. In this case, the touch panel 652 provides a tactile reaction to the user.

The (digital) pen sensor 654 may be implemented using a method identical or similar to a method of receiving a touch input of the user, or using a separate recognition sheet.

The key 656 may include a physical button, an optical key, or a key pad.

The ultrasonic input device 658 is a device which can detect an acoustic wave by a microphone (for example, microphone 688) of the electronic device 601, through an input means generating an ultrasonic signal, to identify data. The ultrasonic input device 658 can perform wireless recognition.

According to an embodiment, the electronic device 601 receives a user input from an external device (for example, computer or server) connected to the electronic device 601 by using the communication module 620.

The display 660 (for example, the display module 140) includes a panel 662, a hologram device 664, and a projector 666.

The panel 662 may be a Liquid Crystal Display (LCD) or an Active Matrix Organic Light Emitting Diode (AM-OLED). The panel 662 may be implemented to be flexible, transparent, or wearable. The panel 662 may be configured to be integrated into the touch panel 652 or may be configured as one module.

The hologram device 664 displays a stereoscopic image in the air by using interference of light.

The projector 666 projects light on a screen to display an image. The screen may be located inside or outside the electronic device 601. The display 660 may further include a control circuit for controlling the panel 662, the hologram device 664, and the projector 666.

The interface 670 includes a High-Definition Multimedia Interface (HDMI) 672, a Universal Serial Bus (USB) 674, an optical interface 676, and a D-subminiature (D-sub) 678. Additionally or alternatively, the interface 690 may include a Mobile High-definition Link (MHL) interface, a Secure Digital (SD) card/Multi-Media Card (MMC), or an Infrared Data Association (IrDA) standard interface.

The audio module 680 bi-directionally converts a sound and an electronic signal. The audio module 680 processes sound information input or output through, for example, a speaker 682, a receiver 684, an earphone 686, a microphone 688 or the like.

The camera module 691 is a device which can capture a still image and a video. The camera module 991 may include one or more image sensors (for example, a front sensor or a back sensor), an Image Signal Processor (ISP) or a flash (for example, an LED or xenon lamp).

The power managing module 695 manages power of the electronic device 601. The power managing module 695 may include a Power Management Integrated Circuit (PMIC), a charger Integrated Circuit (IC), or a battery gauge.

The PMIC may be mounted to an integrated circuit or an SoC semiconductor. A charging method is divided into wired and wireless methods. The charger IC charges a battery and prevents over voltage or over current from flowing from a charger. The charger IC may include a charger IC for at least one of the wired charging method and the wireless charging method.

The wireless charging method may include, for example, a magnetic resonance method, a magnetic induction method, and an electromagnetic wave method. Additional circuits for wireless charging, for example, circuits such as a coil loop, a resonant circuit, a rectifier or the like may be added.

The battery gauge measures, for example, a remaining quantity of the battery 696, or a voltage, a current, or a temperature during charging.

The battery 696 stores or generates electricity and supplies power to the electronic device 601 by using the stored or generated electricity. The battery 696 may include a rechargeable battery or a solar battery.

The indicator 697 shows particular statuses of the electronic device 601 or a part (for example, AP 610) of the electronic device 601, for example, a booting status, a message status, a charging status, and the like.

The motor 698 converts an electrical signal to a mechanical vibration.

The electronic device 601 may include a processing unit (for example, a GPU) for supporting a module TV. The processing unit for supporting the mobile TV processes media data according to a standard of Digital Multimedia Broadcasting (DMB), Digital Video Broadcasting (DVB), media flow, or the like.

The aforementioned elements of the electronic device according to various embodiments of the present invention may be constituted by one or more components, and the name of the corresponding element may vary with the type of the electronic device. The electronic device, according to various embodiments of the present invention, may include at least one of the aforementioned elements. Some elements may be omitted or other additional elements may be further included in the electronic device. Further, some of the components of the electronic device, according to the various embodiments of the present invention, may be combined to form a single entity, and thus, may equivalently execute functions of the corresponding elements prior to the combination.

The term “module” used in the description of the various embodiments of the present invention may refer to, for example, a “unit”, including one of hardware, software, and firmware, or a combination of two or more of the hardware, software, and firmware. The term “module” may be interchangeable with a term, such as “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. The “module”, according to various embodiments of the present invention, may include at least one of an Application-Specific Integrated Circuit (ASIC) chip, a Field-Programmable Gate Arrays (FPGAs), and a programmable-logic device for performing operations which are known or are to be developed hereafter.

According to various embodiments, at least some of the devices (for example, modules or functions thereof) or the methods (for example, operations) may be implemented by a command stored in a computer-readable storage medium in a programming module form. When he command is executed by one or more processors (for example, the processor 122), the one or more processors executes a function corresponding to the command. The computer-readable storage medium may be, for example, the memory 130. At least a part of the programming module may be executed by the processor 210. At least a part of the programming module may include, for example, a module, a program, a routine, a set of instructions and/or a process for performing one or more functions or methods of the present invention.

The computer readable recording medium includes magnetic media such as a hard disc, a floppy disc, and a magnetic tape, optical media, such as a Compact-Disc Read-Only Memory (CD-ROM) and a DVD, magneto-optical media such as a floptical disk, and hardware devices specifically configured to store and execute program commands, such as a read ROM, a RAM, and a flash memory. In addition, the program instructions may include high level language codes, which can be executed in a computer by using an interpreter, as well as machine codes made by a compiler.

The aforementioned hardware device is configured to operate as one or more software modules in order to perform the operation of various embodiments of the present invention, and vice versa.

A module or a programming module may include at least one of the described component elements, a few of the component elements may be omitted, or additional component elements may be included. Operations executed by a module, a programming module, or other component elements may be executed sequentially, in parallel, repeatedly, or in a heuristic manner. Further, some operations may be executed according to another order or may be omitted, or other operations may be added.

The embodiments of the present invention, disclosed in the specification and drawings are merely presented to easily describe the technical contents of the present invention and to help in the understanding of the present invention, and are not intended to limit the scope of the present invention. Accordingly, the scope of the present invention should be construed to include all modifications or modified forms derived based on the technical idea of the present invention and it should be understood by those skilled in the art that various changes in form and details may be made therein without departing from the spirit and scope of the invention as defined by the appended claims and their equivalents.

What is claimed is:

1. A method of an inter-local network communication of a first electronic device in a first local network, the method comprising:
obtaining, by the first electronic device, address information of a second electronic device in a second local network, from a third electronic device;
forming a communication channel with the second electronic device, based on the address information; and
transferring data between the first local network and the second local network, using the communication channel.

2. The method of claim 1, further comprising:
controlling a local network service operated in the second local network.

3. The method of claim 1, wherein forming the communication channel comprises at least one of
reusing information of a first socket generated for communicating between the first local network and the second local network to generate a second socket for communicating in the first local network;
changing previously generated information of the second socket so that the information of the second socket is equal to the information of the first socket; and
giving a control authority of the first socket to a local network service using the second socket.

4. The method of claim 1, wherein forming the communication channel with the second electronic device comprises forming the communication channel through a hole punching.

5. The method of claim 1, further comprising outputting information from electronic devices in the first local network which are connected to communicate.

6. The method of claim 5, wherein outputting the information from the electronic devices in the first local network comprises at least one of:
designating one or more predetermined areas of a first screen of the first electronic device, wherein each of the one or more predetermined areas corresponds to an electronic device in the first local network, and outputting at least one of a text, an image, and a video transmitted from the electronic devices in the first local network to a corresponding predetermined area of the one or more predetermined areas of the first screen; and
outputting at least a portion of audio data transmitted from the electronic devices in the first local network.

7. The method of claim 1, further comprising:
outputting information from the electronic devices in the second local network, received from the second electronic device.

8. The method of claim 7, wherein outputting the information from the electronic devices in the second local network comprises at least one of:
designating one or more predetermined areas of a second screen of the first electronic device, wherein each of the one or more predetermined areas corresponds to an electronic device in the second local network, and outputting at least one of a text, an image, and a video transmitted from the electronic devices in the second local network to a corresponding predetermined area of the one or more predetermined areas of the second screen; and
outputting at least a portion of audio data transmitted from the electronic devices in the second local network.

9. The method of claim 1, further comprising:
outputting information from electronic devices in the first local network which are connected to communicate and information from electronic devices in the second local network which are connected to communicate, received from the second electronic device of the second local network.

10. The method of claim 9, further comprising:
in response to an input signal generation, removing from a screen of the first electronic device, at least one of information from the electronic devices in the first local network, and information received from the second electronic device of the second local network.

11. A first electronic device for supporting an inter-local network communication, the first electronic device comprising:
a communication module configured to support a communication connection in a first local network and a communication connection with a second local network; and
a control module configured to control the communication module to obtain address information of a second electronic device in the second local network, form a communication channel with the second electronic device in the second local network based on the address information, and transfer data between the first local network and the second local network, using the communication channel.

12. The first electronic device of claim 11, wherein the control module is further configured to control a local network service operated in the second local network.

13. The first electronic device of claim 11, wherein the control module is further configured to reuse information of a first socket generated for communicating with the second electronic device in the second local network to generate a second socket for communication in the first local network in a case of forming the communication channel, change previously generated information of the second socket so that the information of the second socket is equal to the information of the first socket, or give a control authority of the first socket to a local network service using the second socket.

14. The first electronic device of claim 11, wherein the control module forms the communication channel with the second electronic device in the second local network through a hole punching.

15. The first electronic device of claim 11, further comprises at least one of a display module, and an audio process module, the display module and audio process module each configured to output at least one of information from electronic devices in the first local network which are connected to communicate, and information from electronic devices in the second local network which are connected to communicate, received from the second electronic device of the second local network.

16. The first electronic device of claim 15, wherein the control module is further configured to designate one or more predetermined areas of a first screen of the first electronic device, wherein each of the one or more predetermined areas corresponds to an electronic device in the first local network; and
wherein the display module is further configured to output at least one of a text, an image, and a video transmitted from the electronic devices in the first local network to a corresponding predetermined area of the one or more predetermined areas of the first screen.

17. The first electronic device of claim 15, wherein the control module is further configured to designate one or more predetermined areas of a second screen of the first electronic device, wherein each of the one or more predetermined areas corresponds to an electronic device in the second local network; and
wherein the display module is further configured to output at least one of a text, an image, and a video transmitted from the electronic devices in the second local network to a corresponding predetermined area of the one or more predetermined areas of the second screen.

18. The first electronic device of claim 15, wherein the audio process module is further configured to output at least a portion of audio data transmitted from the electronic devices in the first local network which are connected to community or the electronic devices in the second local network which are connected to communicate.

19. The first electronic device of claim 15, wherein the control module is further configured to remove from a screen of the first electronic device, in response to an input signal generation, at least one of information from the electronic devices in the first local network, and information received from the second electronic device of the second local network.

20. A non-transitory computer-readable recording medium having recorded thereon, a program for executing a method of an inter-local network communication of a first electronic device in a first local network, the program comprising the steps of
obtaining address information of a second electronic device in a second local network, from a third electronic device;
forming a communication channel with the second electronic device, based on the address information; and
transferring data between the first local network and the second local network, using the communication channel.
